(19) United States
(12) Patent Application Publication
(10) Pub. No.: US 2013/0125241 A1
(43) Pub. Date: May 16, 2013

(54) System and/or method relating to a license manager

(71) Applicant: Rick S. Seeler, Scotts Valley, CA (US)

(72) Inventor: Rick S. Seeler, Scotts Valley, CA (US)

(73) Assignee: Adobe Systems Incorporated

(21) Appl. No.: 11/148,598

(22) Filed: Jun. 8, 2005

(51) Int. Cl. G06F 21/10

(52) U.S. Cl. CPC G06F 21/105
USPC 726/26

(57) ABSTRACT

Embodiments of methods, apparatuses, and/or systems relating to a license manager are disclosed.

### BACKGROUND

Various systems and/or methods for granting licenses to use of digital and/or analog media, such as photographs, are known.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a schematic diagram of a possible environment for an embodiment, such as a license manager;

FIG. 2 is a schematic diagram of an embodiment, such as the license manager of FIG. 1;

FIG. 3 is a flow chart of an embodiment, such as a license management process;

FIG. 4 is a schematic diagram of an object including a license indicator; and

FIG. 5 is a schematic diagram of an article having stored thereon instructions that may, when executed, result in an embodiment of a method, a system, and/or an apparatus relating to license management.

### DETAILED DESCRIPTION

In the following detailed description, numerous specific details are set forth to provide a thorough understanding of claimed subject matter. However, it will be understood by one of ordinary skill that claimed subject matter may be practiced without these specific details. In other instances, methods, procedures, components and/or circuits that would be understood by one of ordinary skill have not been described in detail so as not to obscure claimed subject matter.

Systems exist through which a license grantor may grant licenses to a user for one or more uses of an object. For example, a user may contact the license grantor and obtain one or more licenses to one or more uses of an object. In this context an object may mean a representation and/or an expression of a still image and/or a moving image, a sound file, graphics file, such as one or more animations and/or combinations thereof, for example. Examples of such files may include image files such as JPEG, TIFF, etc., sound files such as MP3, WAV, etc., video files MPEG, AVI, etc., and/or graphics files such as one or more animations, for example. In this context a license may mean a right to exercise one or more intellectual property rights related to one or more objects, such as the right to distribute a copyrighted work, for example. In this context a use may mean a right to use an object in a manner consistent with one or more licensed intellectual property rights, for example. Under current approaches there may be multiple license grantors and a single license grantor may be authorized to grant licenses for a particular object.

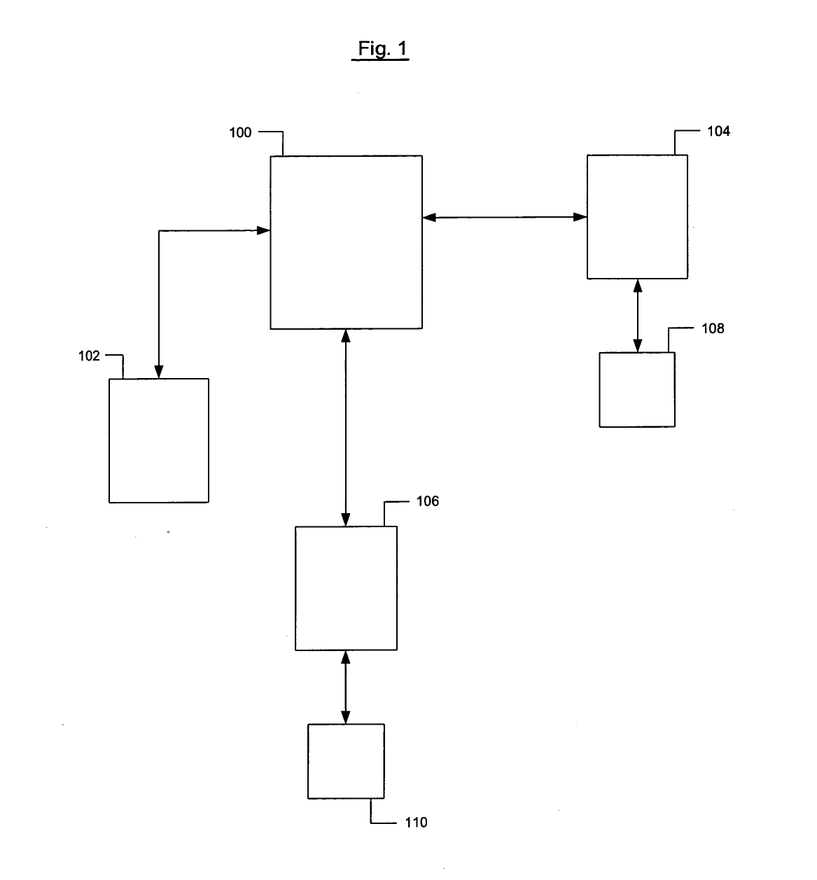

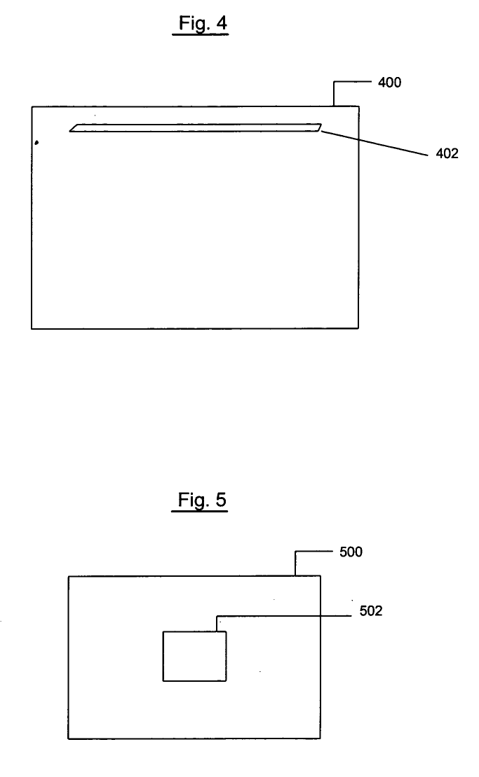

FIG. 1 is a schematic diagram of an environment for an embodiment 100, such as a license manager, an electronic license manager, and/or a license management interface, for example. In this context an electronic license manager may mean software, firmware, freeware, shareware, hardware, and/or combinations thereof capable of at least confirming that conflicting licenses are not granted for one or more uses of at least one object, for example. In this context a license management interface may mean an interface capable of allowing a user to obtain one or more non-conflicting licenses for one or more uses of one or more objects, for example. In this context confirm may mean to establish and/or verify. In this context a non-conflicting use may mean a use that has not already been licensed to a different user, for example. In this context an inconsistent use may mean a use that may not be available based at least in part on one or more existing licenses to a different user, for example. For example, if a request is made for an exclusive use of an object, the requested exclusive use may be inconsistent with a prior license for one or more non-exclusive uses. Likewise, a request for a non-exclusive use may not be available based at least in part on one or more licenses for one or more exclusive uses, for example. In this context a conflicting license may mean a license to one or more uses that may not be available based at least in part on one or more existing licenses, for example. By way of example, a license for a non-exclusive use of an object may comprise a conflicting license based at least in part on an existing exclusive license. Likewise, a license for an exclusive use may comprise a conflicting license based at least in part on one or more existing non-exclusive licenses, for example. Embodiment 100 may be configured to communicate with one or more databases, such as rights management database 102, for example. Rights management database 102 may comprise one or more databases containing information relating to one or more objects, such as one or more digital objects, an example of which is described with regard to FIG. 4, for example. The information in database 102 may relate to one or more uses of the one or more objects. It should be noted that the foregoing example of a license manager is provided for illustrative purposes and that claimed subject matter is not limited in this regard. For example, database 102 may comprise one or more tables (not shown), such as one or more tables containing one or more indications of one or more uses relating to the one or more objects. In this way the availability of a particular use of at least one object may be determined at least in part by querying database 102 for information about the at least one object and/or the particular use, for example. Though, again it should be noted that claimed subject matter is not limited in this regard.

Embodiment 100 may be further configured to communicate, such as via one or more computer networks, such as the internet, one or more local area networks, one or more wide area networks, and/or combinations thereof, with one or more license granting components, such as first license grantor 104 and/or second license grantor 106, for example. In this context, a license granting component may mean software, firmware, freeware, shareware, hardware, and/or combinations thereof witch may be configured to grant at least one license to one or more uses of at least one object, for example. For example, embodiment 100 may be configured to receive a request from first license grantor 104 and/or second license grantor 106 the license of, and/or information relating to, one or more uses of one or more objects. Additionally, embodiment 100 may be further configured to send information relating to the availability of the one or more uses of the one or more objects to first license grantor 104 and/or second license grantor 106. In this context information relating to one or more uses of one or more objects may comprise information such as information indicating one or more available uses of the one or more objects and/or information indicating one or more uses of the one or more objects that are not available for licensing, for example. In this context an available use may mean one or more uses that are not currently licensed, not currently exclusively licensed, and/or not in conflict with one or more existing licenses, to name but a few examples. Though, again, the above example relating to a license manager is provided for illustrative purposes only and claimed subject matter is not limited in this regard. First license grantor 104 and second license grantor 106 may be configured to interact with a first user 108 and/or a second user 110, for example. First user 108 and/or second user 110 may interact with first license grantor 104 and/or second license grantor 106 to attempt to obtain information and/or licenses for one or more uses of one or more objects and/or download one or more versions of the one or more objects, for example. Though, again, it should be noted that this is merely an example relating to a license manager and that claimed subject matter is not limited in this regard.

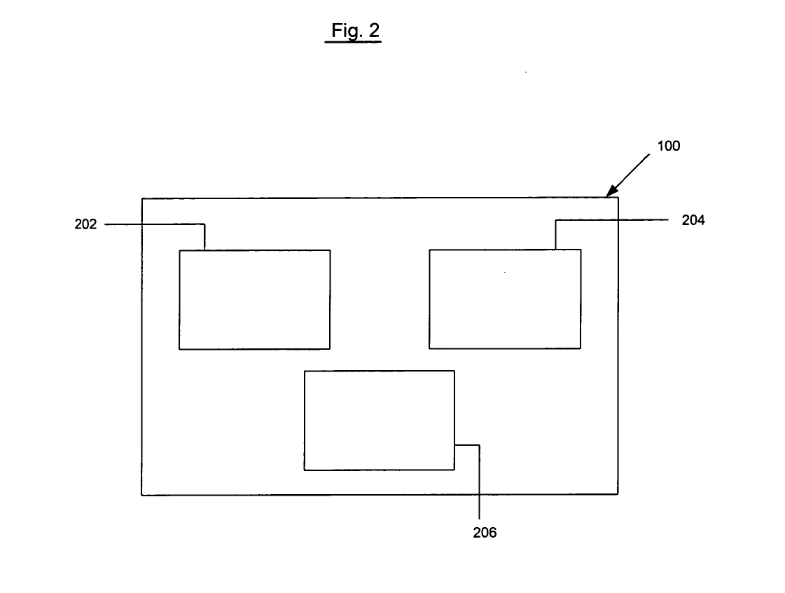

FIG. 2 is a schematic diagram of embodiment 100, such as an electronic license manager, for example. For illustrative purposes, embodiment 100 may comprise one or more components, such as a license grantor interface 202, a license database interface 204, and/or a controller module 206 for example. In this context, license grantor interface 202 may comprise a portion of an object oriented program formed at least in part by embodiment 100, a sub-routine of embodiment 100, a program configured to interact and/or communicate with embodiment 100, and/or combinations thereof, for example. License grantor interface 202 may be configured to allow one or more license granting components, such as first license grantor 104 and/or second license grantor 106, to communicate with embodiment 100, for example. By way of illustration, license grantor interface 202 may be configured to send messages to, and/or receive messages from, first license grantor 104 and/or second license grantor 106, for example. Though, again, it should be noted that claimed subject matter is not limited in this regard.

In this context, license database interface 204 may comprise a portion of an object oriented program formed at least in part by embodiment 100, a sub-routine of embodiment 100, a program configured to interact and/or communicate with embodiment 100, and/or combinations thereof, for example. Though, again, it should be noted that claimed subject matter is not limited in this regard. License database interface 204 may be configured to communicate with one or more databases, such as license management database 102, for example. In this context license management data base 102 may comprise one or more relational databases, object oriented databases, hierarchical databases, flat file databases and/or combinations thereof, for example. In this context, communicating with license management database 102 may comprise submitting one or more queries to license management database 102 and/or receiving one or more query results from license management database 102, for example. By way of illustration, license database interface 204 may be configured to submit a query relating to one or more uses of one or more objects to license management database 102. In this context, the query may comprise one or more appropriately formatted instructions for license management database 102, and/or associated database management programs (not shown), to search for information relating to one or more uses of one or more objects, for example. License database interface 204 may be further configured to receive a result of the query relating to one or more uses of one or more objects from license management database 102, for example. In this context, the result may comprise information relating to the availability of one or more uses of one or more objects, for example. Though, again, it should be noted that the above described license manager structure is provided by way of example and that claimed subject matter is not limited in this regard.

Controller module 206 may comprise a portion of an object oriented program formed at least in part by embodiment 100, a sub-routine of embodiment 100, a program configured to interact and/or communicate with embodiment 100, and/or combinations thereof, for example. Though, again, it should be noted that claimed subject matter is not limited in this regard. Controller module 206 may be configured to interact, such as sending and/or receiving messages and/or data from license grantor interface 202 and/or license database interface 204, for example. By way of illustration, controller module 206 may be configured transform information received from license grantor interface 202 into a format compatible with license database interface 204, for example. Controller module 206 may be further configured to send the transformed data to license database interface 204, for example. Though, again, it should be noted that claimed subject matter is not limited in this regard. Controller module 206 may be further configured to receive information from license database interface 204 and transform the information into a format compatible with license grantor interface 202, for example. Controller module 206 may be further configured to send the transformed information to license grantor interface 202, for example. Controller module 206 may further be configured to transfer the information regarding a particular object to a secondary controller (not shown), thereby transferring management of that object to the secondary controller. Though, again, it should be noted that claimed subject matter is not limited in this regard.

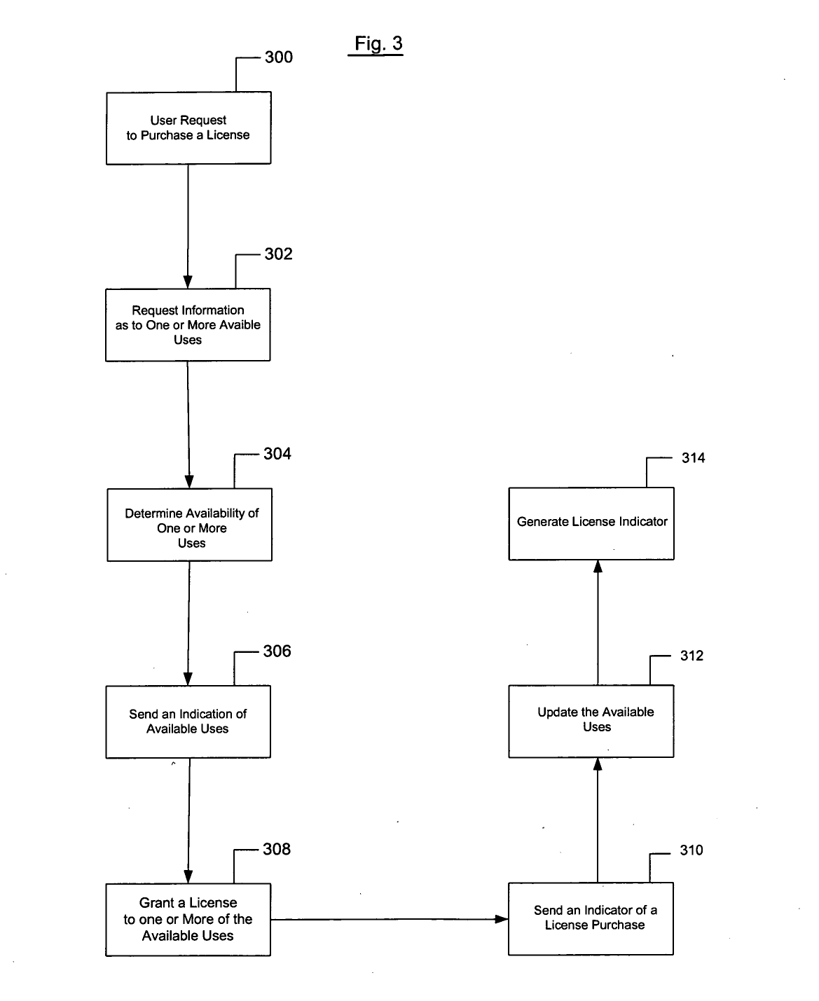

FIG. 3 is a flow chart of an embodiment, such as a license management method, for example. With regard to box 300, a user (not shown) may request to purchase a license, such as a license for one or more uses of at least one object, such as a digital object, for example. As discussed above, the at least one object may comprise one or more digital objects, such as one or more still images, one or more moving images, one or more sound files, one or more data files, and/or combinations thereof. Though, again, it should be noted that claimed subject matter is not limited in this regard. In this context, the user may make the request using one or more computing devices, such as a computer attached to a computer network, for example.

Additionally, the user may make the request using one or more programs comprising software, firmware, shareware, freeware, and/or combinations thereof, such as a web browser, for example. For example, the user may select one or more digital images displayed on a web page, such as by clicking on an icon associated with the one or more digital images. Additionally, the user may select, such as by clicking on a check box, and/or highlighting a selected use in any of a number of ways, such as clicking on a selected portion of a menu, such as a drop down menu, to name but a few examples, one or more uses, such as use in one more industries, regions, media formats, and/or combinations thereof, to name but a few examples. Though, again, it should be noted that claimed subject matter is not limited in this regard. The user may then submit a request to the one or more license granting components to check the availability of the selected one or more uses, for example. Additionally, the user may submit a request, such as by clicking on an icon, to the one or more license granting components to receive and/or obtain a license for the one or more selected uses. Though, again, it should be noted that claimed subject matter is not limited in this regard. The request from the user may be received by the one or more license granting components, such as first license grantor 104 and/or second license grantor 106, for example.

With regard to box 302, the one or more license granting components may request and/or determine one or more licenses for one or more available uses of the at least one object, for example. In this context, determining may mean finding out or coming to a decision about by investigation, reasoning, or calculation, for example. In this context, the one or more license granting components may determine one or more available uses by communicating with a license manager, such as embodiment 100, for example, to determine one or more available uses for the at least one object. In this context, communicate may comprise sending one or more messages and/or receiving one or more message, for example. For example, the one or more license granting components may send one or more messages requesting information relating to the availability of the selected one or more uses of at least one object to the license manager, for example. Though, again, it should be noted that claimed subject matter is not limited in this regard.

With regard to box 304, the license manager may, in response to the request from the one or more license granting components, determine and/or verify if the one or more uses are available, such as by looking up one or more tables in one or more databases to determine if the selected uses are available, for example. In this context looking up the one or more tables may comprise submitting one or more queries relating to the at least one object to the one or more databases. The one or more tables may at least include information as to one or more uses related to the at least one object stored in one or more databases, for example.

With regard to box 306, once the license manager has determined if the one or more uses are available the license manager may communicate whether or not the one or more uses are available to the one of more license granting components. For example, the license manager may send a message comprising an indicator of the determined one or more uses to the one or more license granting components. Though, again, this is just an example of a license managing process and it should be noted that claimed subject matter is not limited in this regard. For example, if the license manager determines that a license to the one or more uses is available, then the license manager may send a message to the one or more license granting components giving permission and/or authorization for the requesting license granting component to grant a license for the one or more uses to the user. Though, again, it should be noted that this is just an example of a license managing process and that claimed subject matter is not limited in this regard.

With regard to box 308, the one or more license granting components may display the determined license for one or more available uses to the user. The user may select one or more of the determined one or more available uses and proceed to purchase a license for the selected one or more uses, such as by clicking on a purchase icon, for example. Though, again, it should be noted that claimed subject matter is not limited in this regard. The one or more license granting components may complete the purchase using any of a number of Internet based transaction techniques. With regard to box 310, once the license purchase has been completed, the one or more license granting components may send an indication of the purchased license for the one or more uses to the license manager, such as by sending one or more messages to the license manager, for example. Though, again, it should be noted that claimed subject matter is not limited in this regard.

With regard to box 312, the license manager may as appropriate update the available uses for the at least one object such as by updating one or more tables of uses relating to the at least one object, for example. Here, such an update of one or more tables may be based at least in part on the received indication that one or more licenses were granted. In this context, updating the one or more tables may comprise changing the one or more tables based at least in part on the one or more license granting components granting a license for one or more uses of the at least one object to the user, for example. For example, in response to receiving an indication that a license for one or more uses of at least one object has been purchased the license manager may update a database entry relating to the at least one object. In this context the database update may comprise updating a table associated with the at least one object such that the licensed one or more uses may be listed as having been granted for a period of time, such as for a duration of the granted license, for example. In the case where an exclusive license has been granted, the table associated with the at least one object may be updated so that the licensed one or more uses may be listed as unavailable for a period of time, such as for a duration of the granted license, for example. Though, again, it should be noted that claimed subject matter is not limited in this regard. In this way, one or more license granting components may be able to grant licenses to the same at least one object while avoiding granting inconsistent licenses to the at least one object, for example. Though, of course, claimed subject matter is not limited in this regard.

With regard to box 314, the license manager may generate a license indicator, such as that described with reference to FIG. 4, for example. In this context, the license indicator may be included as a portion of one or more downloadable versions of the at least one object and/or may be associated with the one or more downloadable versions of the at least one object, for example. In this context a downloadable version of an object may comprise a version of the object, such as a version of the object having a particular resolution, which a user may download from one or more locations, such as one or more license granting components, the license manager, and/or some other location. The license manager may send the license indicator to the one or more license granting components so that the user may have access to the license indicator, for example. Though, again, it should be noted that the above process is provided for illustration only and that claimed subject matter is not limited in this regard.

FIG. 4 is a schematic diagram of an object 400, such as at least one of the objects described, which may including a license indicator 402. In this context a license indicator may mean data at least in part related to one or more licenses for at least one object, for example, such as one or more portions of extensible metadata platform (XMP) compatible data, for example. Though, again, it should be noted that claimed subject matter is not limited in this regard. For example, object 400 may comprise a digital image for which a user has purchased a license for one or more uses, such as described above, and/or a complimentary version of a digital image, for example. In the case where object 400 may comprise a digital image for which a user has purchased a license for one or more uses, license indicator 402 may comprise one or more universal resource locators (URLs) which may direct one or more programs, such as a web browser, to a visual representation of the license purchased, for example. In this way, users may readily determine if an additional license should be purchased for a proposed use of the digital image by clicking on license indicator 402 so that a web browser (not shown) displays one or more visual representations of one or more licenses that have already been obtained. Though, again, it should be noted that claimed subject matter is not limited in this regard. In the case where object 400 may comprise a complimentary digital image, license indicator 402 may comprise one or more URLs which may direct one or more programs to a visual representation of one or more available licenses for the complimentary images and/or an interface, such as an interface for one or more license grantors, from which a user may search for, and/or obtain, a license for one or more available uses of object 400, for example.

In this context license indicator 402 may comprise a hidden portion of object 400, a visible portion of object 400, and/or a selectively visible portion of object 400, for example. License indicator 402 may comprise information as to who has purchased the license for object 400, an object id, such as an at least somewhat unique identifier for object 400, a link, such as a URL, to a license manager, a link, such as a URL, to one or more license grantors, information relating to an author and/or creator of the object, data relating to one or more characteristics of the object, and/or combinations thereof. Though, again, it should be noted that the above object has been described for illustrative purposes and that claimed subject matter is not limited in this regard.

FIG. 5 is a schematic diagram of an article 500 having stored thereon instructions 502 that may, when executed, result in an embodiment of a method of license management, an apparatus, and/or a system, such as one or more of the above-described embodiments.

It will, of course, also be understood that, although particular embodiments have just been described, claimed subject matter is not limited in scope to a particular embodiment or implementation. For example, one embodiment may be in hardware, such as implemented on a device or combination of devices, as previously described, for example. Likewise, although the claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, the claimed subject matter is not limited in scope to this example.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

1-16. (canceled)

17. A method for a license manager to provide information to a plurality of distinct license granting components for use by the license granting components to grant licenses to users requesting licenses from the license granting components, said method comprising:
receiving, by the license manager implemented by one or more computing devices, requests from the plurality of distinct license granting components, each request is for information on availability for use by a respective license granting component in granting a particular license to one of the users requesting the particular license from the respective license granting component in regard to a particular object, wherein the requests are received via an electronic communications network.
in response to at least one of the requests:
determining, by said license manager, that the particular license requested by the request is a non-conflicting license that is not inconsistent with a license already granted by at least one other license granting component in regard to the particular object, wherein said determining comprises querying a license management database storing data sets indicating license availability information about a plurality of objects; and
responding, without granting the particular license by said license manager, to the particular license granting component with the information on availability indicating that the particular license in regard to the particular object is a non-conflicting license.

18. The method of claim 17, wherein said plurality of objects comprises one or more digital objects.

19. The method of claim 17, wherein said responding comprises transmitting data indicating one or more available uses to the requesting license granting component via said electronic communications network.

20. The method of claim 17, and further comprising:
updating said data sets indicating license availability information about said plurality of objects based at least in part on one or more licenses granted by one or more of the plurality of license granting components.

21. (canceled)

22. The method of claim 17, wherein said responding comprises authorizing said particular license granting component to grant one or more non-conflicting licenses licensing one or more determined available uses of said particular object.

23. The method of claim 17, wherein said plurality of objects comprises one or more still images, one or more moving images, one or more sounds, and/or combinations thereof

24-26. (canceled)

27. A non-transitory storage medium storing program instructions for a license manager to provide information to a plurality of distinct license granting components for use by the license granting components to grant licenses to users requesting licenses from the license granting components, wherein the program instructions, when executed by one or more processors, cause a computing device to perform:
receiving, by the license manager implemented by one or more computing devices, requests from the plurality of distinct license granting components, each request is for information on availability for use by a respective license granting component in granting a particular license to one of the users requesting the particular license from the respective license granting component in regard to a particular object, wherein the requests are received via an electronic communications network; and
in response to at least one of the requests:
determining, by said license manager implemented by said computing device, that the particular license requested by the request is a non-conflicting license that is not inconsistent with a license already granted by at least one other license granting component in regard to the particular object, wherein said determining comprises querying a license management database storing data sets indicating license availability information about a plurality of objects; and
responding, without granting the particular license by said license manager implemented by said computing device, to the particular license granting component with the information on availability indicating that the particular license in regard to the particular object is a non-conflicting license.

28. The non-transitory storage medium of claim 27, wherein said plurality of objects comprises one or more digital objects.

29. The non-transitory storage medium of claim 27, wherein said instructions are further executable by said one or more processors to indicate one or more available uses to the particular license granting component as part of said responding.

30. The non-transitory storage medium of claim 27, wherein said instructions are further executable by said one or more processors to update said data sets indicating license availability information about said plurality of objects based at least in part on one or more licenses granted by one or more of the plurality of license granting components.

31. The non-transitory storage medium of claim 27, wherein said instructions are further executable by said one or more processors to update said data sets in regard to a determined use of one of the plurality of objects in response to one of the license granting components granting a license licensing the determined use.

32. The non-transitory storage medium of claim 27, wherein said instructions are further executable by said one or more processors to authorize said particular license granting component to grant one or more non-conflicting licenses for one or more available uses of the particular object.

33. The non-transitory storage medium of claim 32, wherein said plurality of objects comprises one or more still images, one or more moving images, one or more sounds, and/or combinations thereof.

34. (canceled)
